(19) United States
(12) Patent Application Publication
(10) Pub. No.: US 2026/0034014 A1
(43) Pub. Date: Feb. 5, 2026

(54) Adjustably Controlling the Percentage of a Users' Weight to be Borne by a User's Afflicted Weight bearing Joints Facilitates Substantially Pain Free Movement While Promoting Rehabilitation Thereof

(71) Applicant: Fahmi Qassem, Newmilford, CT (US)

(72) Inventor: Fahmi Qassem, Newmilford, CT (US)

(21) Appl. No.: 18/789,671

(22) Filed: Jul. 30, 2024

(51) Int. Cl. A61H 3/00

(52) U.S. Cl. CPC A61H 3/00; A61H 2003/007; A61H 2201/1642

(57) ABSTRACT

A support frame is designed to bear a percentage of a user's weight and thereby reduce by that amount the remaining weight that must be borne by the user's joints. The adjustment can be made by preloading or pre-compressing springs that are part of the support frame, thereby increasing the amount of weight required to begin compressing the spring as a function of its initial spring rate. By adjusting the precompression of the springs, a critical value of the percentage of displaced user weight can be established for a user that will permit the user to move afflicted joints with a satisfactory reduction of pain and discomfort that is acceptable to the user at that moment in time.

### CROSS-REFERENCE TO RELATED APPLICATIONS

This application claims priority as a continuation-in-part of U.S. application Ser. No. 17/803,846, filed Dec. 27, 2022 and titled “Golden Leg,” and which is hereby incorporated herein, in its entirety, by this reference.

### FIELD OF THE INVENTION

The invention relates to facilitating the rehabilitation of a person's joints that are afflicted with pain due to injury or arthritis, and more particularly to reducing the weight to be borne by the person's afflicted joints to a percentage of the person's full weight, the percentage being a value at which the person is able to move and therefore rehabilitate the afflicted joints while being substantially free of pain while doing so.

### BACKGROUND OF THE INVENTION

It is estimated that over 344 million people worldwide currently suffer from some type of arthritis. Arthritis can afflict numerous joints in the body, such as the knee, ankle, hip and vertebrae in the back. Symptoms of arthritis can include debilitating pain experienced both during and/or after the physical articulation or movement of weight-bearing joints. Additional symptoms can include joint stiffness (especially after extended inactivity), tenderness, loss of flexibility, grating sensation, bone spurs, and swelling.

Severe joint pain (SJP) is a common outcome among adults with arthritis that can limit a person's ability to perform basic functions and can seriously compromise quality of life (e.g., restrict work and social participation that can lead to losses in income and depression). Regular physical activity can: 1) prevent weight gain that would otherwise increase the burden on afflicted weight bearing joints; 2) help keep the muscles around afflicted joints strong; 3) decrease bone loss and may help control joint swelling and pain; and 4) compresses joints to force more nutrient-rich fluid and blood flow into the cartilage to replenish lubrication to the cartilage that reduces stiffness and pain and encourages the creation of new cartilage. Of course, one of the most effective (and perhaps the most often prescribed) ways to reduce or even eliminate the symptoms of arthritis is to lose weight.

Unfortunately, the symptoms of arthritis experienced by people with afflicted joints can quite often discourage, interfere with or even render impossible their engaging in the physical activity and movement that can alleviate and ultimately rehabilitate those afflicted joints. Indeed. weight gain from lack of movement and physical activity can only further exacerbate the symptoms.

Thus, people suffering from weight-bearing joints afflicted with arthritis would benefit from an intervention that could facilitate their ability to engage in normal movement and physical activity required for work and social activities, as well as the kind of physical activities that can promote the rehabilitation of those afflicted joints naturally. This would be greatly preferable to pharmaceutical solutions that only treat symptoms and often cause harmful side-effects.

### SUMMARY OF THE INVENTION

The support frame of the invention is designed to bear a percentage of the a user's weight and thereby reduce by that amount the remaining weight that must be borne by the user's joints, and particularly the user's load bearing joints such as the ankles, knees, hips and vertebrae. The adjustment can be made easily by preloading or pre-compressing springs that are part of the support frame, thereby increasing the amount of weight required to begin compressing the spring as a function of its initial spring rate. By adjusting the precompression of the springs, a critical value of the percentage of displaced user weight can be established for a user that will permit the user to move afflicted joints with a satisfactory reduction of pain and discomfort that is acceptable to the user at that moment in time.

Once the critical value is presently determined and implemented, a user can wear the support frame whenever needed to facilitate movement for purposes of achieving the mobility to perform work and/or social activities, as well as exercise activities that can promote rehabilitation (e.g., healing and reduced inflammation, improved flexibility and range of motion, restoration of cartilage in the operation of the afflicted joints and loss of weight). As the condition of the afflicted joint(s) improve, the critical value of the percentage can be decreased (thereby increasing the amount of the user's weight being borne by the afflicted joints) to establish a new critical value, by simply increasing the precompression of the spring.

In a method of treating/rehabilitating afflicted joints using the support frame of the invention, the process of periodically establishing new critical values of the percentage can be performed under the supervision of a health professional such as a physical or occupational therapist to achieve long-term positive outcomes such as complete rehabilitation of the afflicted joints to long-term management of the afflicted joints to maximize a user's quality of life.

### BRIEF DESCRIPTION OF THE DRAWINGS

FIG. 1 is a front view of an embodiment of the support frame of the invention as worn by a human user that adjustably removes a percentage of the user's weight borne by the user's knee and ankle joints;

FIG. 2 is a front view of an embodiment of the support frame of the invention as worn by a human user that adjustably removes a percentage of the user's weight borne by the user's vertebrae, hip, knee and ankle joints;

FIG. 3 is a side view of the embodiment of the support frame of the invention shown in FIG. 1;

FIG. 4 is a side view of the embodiment of the support frame of invention shown in FIG. 2 worn in conjunction with a torsion spring to assist a user in climbing and descending stairs;

FIG. 5 is a rear facing view of the embodiment of the support frame of the invention as shown in FIG. 2, including additional bracing components for correcting curved knees; and

FIG. 6 is a rear facing view of the embodiment of the support frame of FIG. 2, worn by a healthy user for improving the user's ability to carry heavy loads.

### DETAILED DESCRIPTION

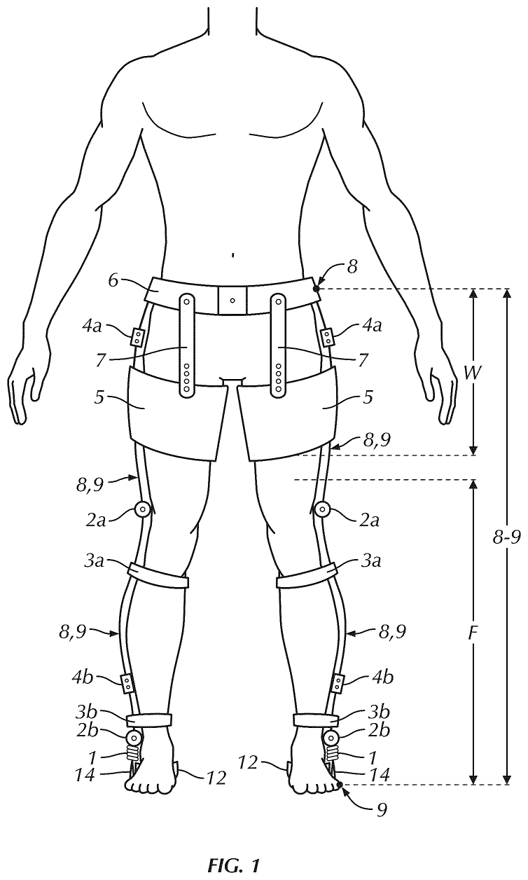

FIG. 1 illustrates an embodiment of the support frame 8, 9 of the invention. The support frame 8, 9 is comprised of two portions, each portion running substantially along a different leg of the user. Each portion of the support frame 8, 9 is coupled to a fixing belt 6 at a first or top end 8 of each portion of the support frame 8, 9. Each portion of the support frame 8, 9 can be constructed from materials such as stainless steel, steel, aluminum or hard plastic, as long as the material provides sufficient rigidity suitable to support the maximum value of the percentage of a user's weight.

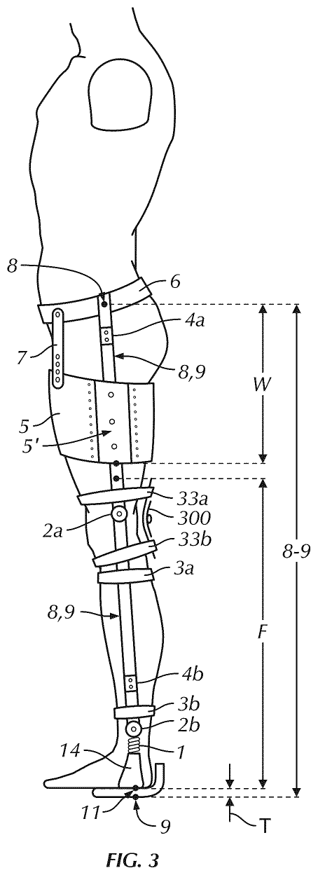

The fixing belt 6 is commonly coupled to both portions of the support frame 8, 9 by any suitable technique. Each portion of the support frame 8, 9 is coupled to a corset belt 5 at portion 5′ (FIG. 3) that is affixed to or worn by the leg associated therewith. The fixing belt 6 is further coupled to each of the corset belts 5 through an adjust belt 7. Each adjustment belt 7 ensures that the corset belt is supported and can be adjusted in length to accommodate users of different dimensions. Components 5, 6 and 7 transfer a percentage of the user's weight to each of the portions of the support frame 8, 9.

Fixing bands 3a, 3b serve to retain each of the support frame 8, 9 portions to their respective legs, and can be bands of hook and loop fasteners. Each portion of the support frame 8, 9 further includes rotating components 2a and 2b, to permit articulation of the knee joints (2a) and the ankle joints (2b). The rotating components can include a means for limiting the range of rotation permitted.

Each portion further includes adjustable hitch components 4a, 4b for adjusting the length of segments of each portion by which to accommodate users of various dimensions. For example, adjustable component 4a can be used to position rotational component 2a at the knee joint and adjustable component 4b can be used to position rotational component 2b proximally with the ankle joint. Those of skill in the art will appreciate that metal frames can be lengthened with sliding overlapping pieces that can be secured in discreet fractions of the total overlapping length.

The spring 1 is placed in series with each portion and can be configured to operate over various ranges of a user weight by adjusting the spring constant of spring 1. Moreover, the ability of the user's weight placed over the portions of the support frame 8, 9 to lift the user can be adjusted for a spring with a given spring constant by pre-compressing the spring and shortening the length of the spring and thus the amount of weight that can be offloaded to the support frame. This can be accomplished with threaded nuts that can be used to compress and decompress the spring 1.

At the very bottom of each of the portions of the support frame 8, 9 are the foot plates 12 that are coupled to the spring 1 through connecting piece 14. A compressible insole material 11 can be placed between the foot plate 12 and the user's foot that further resists the user's weight applied being imposed on the joints. The thicker the insole material (T), the more weight is removed from the afflicted joints.

The section of each portion marked W includes the components of the invention that apply the user's weight at the maximum position point 8 of each portion of the support frame 8, 9. The section marked F is the zone where the user experiences a reduction in weight as applied to the joints in zone F due to the displacement of spring 1.

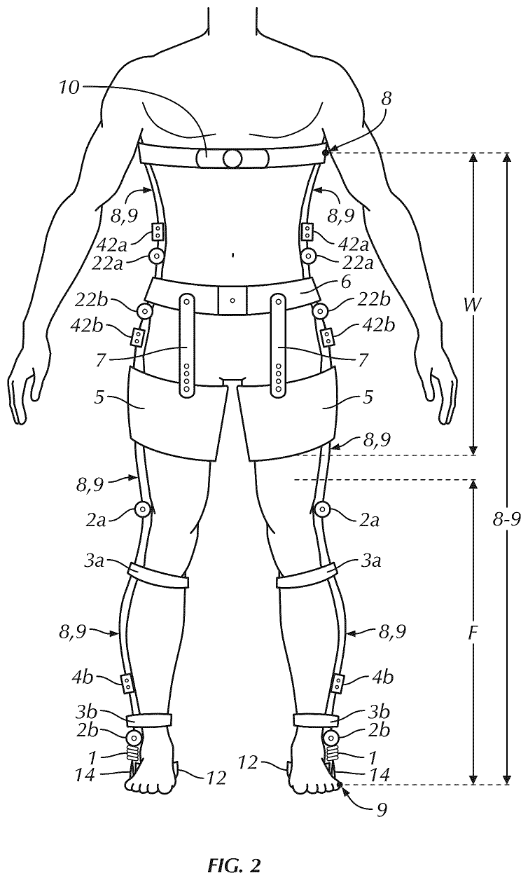

FIG. 2 is an embodiment of the support frame 8, 9 that has been extended up to a maximum position 8 at just below the arm pits of the user. Thus, the weight of the user is applied to the support frame so that when spring 1 is displaced, a weight, which is a percentage of the user's weight is subtracted from the user's full weight as applied to the hip joints as well as from the vertebrae of the back. The W section now includes the corset belt 10 as well components 5, 6 and 7 from the FIG. 1. Put another way, the zone F has been extended up to the armpits through the addition of the corset belt 10 that is coupled with the extended portions of the support frame at the elevated point just below the armpits. This is similar to an application of the user's body weight to a crutch, except that the application of the body weight to the elevated location 8 allows the subtraction of weight to occur from the elevated point 8 of FIG. 2 rather than the lower waist level point 8 in FIG. 1. When the support frame compresses spring 1 in each of the portions, the user's full weight is decreased by a percentage of the user's full weight that is dictated by the spring rate of spring 1 and the linear displacement of the spring 1 as it compresses. As such, not only are the knee and ankle joints located in the F zone in which a percentage of the user's full weight has been subtracted, but this is also true at the hip and the vertebrae below the armpits below point 8.

It should also be pointed out that in extending the portions of the support base 8, 9, additional adjustable hitch components 42a, b are included in each portion to accommodate differences in the upper dimensions of user's. Additional rotational components 22a, b were also added to accommodate articulation of the hip and vertebrae in the user's back.

FIG. 3 is a side view of a user wearing the support frame 8, 9 of the invention as depicted in FIG. 1. This embodiment is most applicable to a user that has an afflicted knee joint, but healthy back vertebrae and hips. In this embodiment, it is also illustrated how the support frame 8, 9 of the invention can be used in conjunction with a torsion spring 300 to assist in a user climbing stairs, The torsion spring can be separately attached to the person using two fixing straps 33a and 33b that can be wrapped around the outside of the support frame as shown and can be secured using hook and loop material or any other suitable strap.

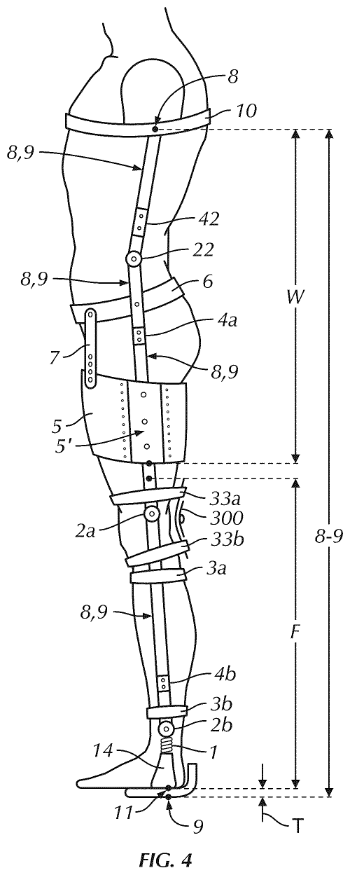

FIG. 4 is a side view of the embodiment of FIG. 2 and shows that the W portion extends all the way up to the point 8 at which at which the user's weight is applied to the top end of both portions of the support frame 8, 9. In this case, the F zone extends from the feet at point 9 all the way up to point 8, and includes hip and vertebrae joints,

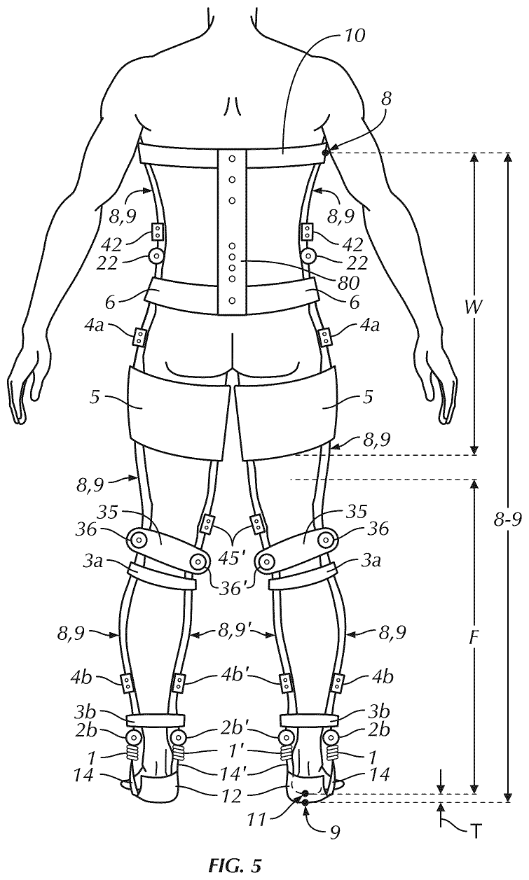

FIG. 5 illustrates a back view of an embodiment that includes two additional portions of support frame 8,9′, that each extend along the inside of the user's legs. Each of the portions of the support frame 8,9′ are coupled to the corset belts 5 worn by each of their respective legs and to the inside edges of the two respective foot plates 12. Each of the pairs of portions 8,9 and 8,9′ are coupled together with braces 35 and coupled together using attachment means 36 and 36′. This embodiment serves to provide the same benefits as the embodiment of FIGS. 2 and 4, but additionally, the braces can be used to correct curved knees, typically known as knock knees and bowed knees, by directing and maintaining the knees in the correct position.

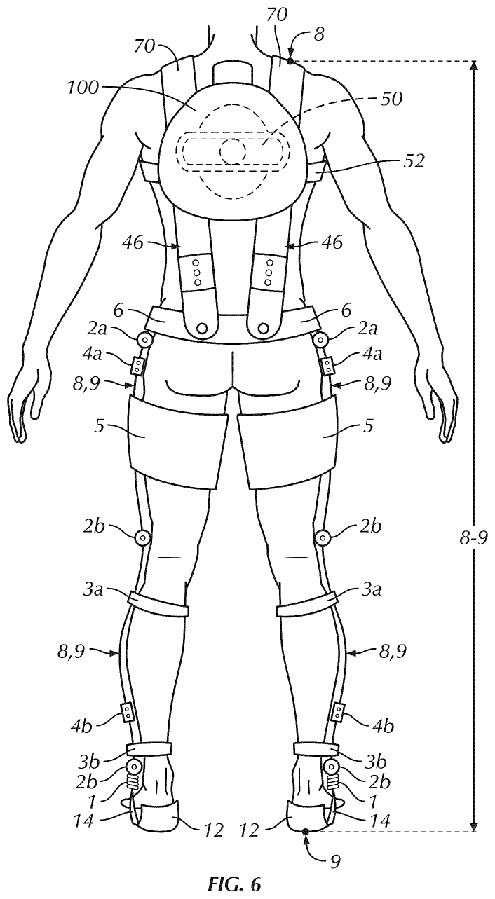

FIG. 6 is as an embodiment of the invention that can be used by healthy user's who would like to enhance their ability to carry heavy loads such as might be stored in back pack 100, the full weight of which is directed through the over the shoulder strap assemblies 70 to allow reduction of weight over the entire length of the body from point 8 at the top of the shoulder through to the bottom of the feet at point 9.

What is claimed is:

1. An apparatus for adjustably controlling the percentage of a user's weight to be borne by the user's afflicted joints, said apparatus comprising:
a weight bearing support frame comprising at least two symmetrical portions, wherein:
when said apparatus is worn by the user while standing, a first end of each of the portions being coupled to the user at a maximum position along the user's body;
each of the portions extend along a different one of the user's legs to a foot base at a second end, the foot base of each portion supporting a respective one of the user's feet;
each of the portions further comprising at least one spring component in series therewith that is adjustable to cause a percentage of the user's body weight to be supported by each portion of the support frame, thereby causing any of the user's joints that fall between the maximum position and the bottom off the user's feet to bear only the remaining percentage of the user's full weight not being borne by the portions of the support frame.

2. The apparatus of claim 1, wherein the adjustable spring of each of the portions can be preloaded to adjust the percentage of the user's weight to be supported by the apparatus.

3. The apparatus of claim 1, wherein the support frame is coupled to the user's waist through a fixing belt attached to each portion of the support frame.

4. The apparatus of claim 3, wherein each of the portions is uniquely coupled to its respective leg by a corset belt, each corset belt being directly coupled to the portion and to the fixing belt.

5. The apparatus of claim 1, wherein each of the portions further includes one or more adjustable hitches that permit the portions to be adjusted in length to accommodate the varying dimensions of users.

6. The apparatus of claim 5, wherein one of one more adjustable hitches adjusts the length of each portion between the waist and the knee of the user.

7. The apparatus of claim 5, wherein one of one more adjustable hitches adjusts the length of each portion between the knee and bottom of the user's foot.

8. The apparatus of claim 4, wherein each portion includes one or more fixing bands to retain each portion's proximity to its respective leg.

9. The apparatus of claim 2, wherein the foot support of each portion is configured to accommodate a soft compressible material that further increases the percentage of the user's weight to be accommodated by the support frame.

10. The apparatus of claim 9, wherein the percentage increases in value proportionally to the thickness between of the orthotic material.

11. The apparatus of claim 1 wherein the maximum position is the user's waist, and the joints benefiting from the weight borne by the support frame are at least the user's knee joints.

12. The apparatus of claim 1 wherein the maximum position of the first end is established by extending the two portions from the user's waist to the user's chest level wherein:
the additional weight is primarily applied at the muscles just below the user's armpits, and
the two portions are coupled to the user using a second corset belt surrounding the chest.

13. The apparatus of claim 12 wherein the joints benefiting from the weight borne by the support frame are at least the user's knee joints, the pelvis and the vertebrae below the maximum position.

14. The apparatus of claim 11 wherein each of the portions includes a rotating element proximate to the knee joint to facilitate bending of the knee joint while wearing said apparatus.

15. The apparatus of claim 11 wherein each of the portions includes at least a rotating element proximate to the pelvis joint and the vertebrae joints to facilitate bending of the back and pelvis joints while wearing said apparatus.

16. A method for rehabilitating an afflicted joint through use, said apparatus comprising:
providing a weight bearing support frame comprising at least two symmetrical portions, each of the portions configured to be coupled at a first end to a maximum position along the user's body, each portion extending along a respective one of the user's legs to a foot base at a second end, each of the portions further comprising at least one spring component in series therewith that is adjustable to cause a critical percentage of the user's body weight to be supported by each portion of the support frame;
adjusting the spring to increase the amount of the user's weight that is borne by the support frame to reach a state whereby the user experiences no pain while articulating the afflicted joint;
periodically adjusting the spring to decrease the weight borne by the support frame to permit the user to further strengthen the joint without experiencing pain; and
discontinuing further rehabilitation when the joint can be articulated without pain when bearing the user's full weight.
